(19) United States
(12) Patent Application Publication
(10) Pub. No.: US 2007/0174228 A1
(43) Pub. Date: Jul. 26, 2007

(54) Graphical representation of key performance indicators

(75) Inventors: Allan Folting, Redmond, WA (US); Amir Netz, Bellevue, WA (US); Konrad Tupaj, Kirkland, WA (US); Robert C. Collie, Kirkland, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/333,895

(22) Filed: Jan. 17, 2006

(51) Int. Cl. G06F 17/30

(52) U.S. Cl. 707/1

(57) ABSTRACT

According to one aspect, key performance indicators and the accompanying key performance indicator elements may be displayed in a task pane to enable a user to select one or more the key performance indicator elements for use in generating a data summary table. In one example, the key performance indicators of a dataset are identified, and each of the associated key performance indicator elements associated with that key performance indicator is also identified. A key performance indicator may be obtained from any source, including the dataset to which it pertains. Additionally, a name of the identified key performance indicator is determined. The determined name and each of the identified key performance indicator elements are displayed in an organized manner as to enable a user easy selection of the key performance indicator and/or the key performance indicator elements.

### CROSS-REFERENCE TO RELATED APPLICATION

This application is related to co-pending U.S. patent application Ser. No. 11/223,527, filed Sep. 9, 2005, entitled “User Interface for Creating a Spreadsheet Data Summary Table,” which is incorporated herein by reference.

### BACKGROUND

Data summary tables may be used to analyze large amounts of data. A data summary table provides an efficient way to display and summarize data supplied by a database program or in a data listing of a spreadsheet. A user can select fields of the data to include within filter, row, column, or data regions of the data summary table and can choose parameters, such as the sum, variance, count, and standard deviation to be displayed for selected data fields. Data in a database that can be queried from within a spreadsheet program, or spreadsheet data including lists, can be analyzed in a data summary table.

Although a data summary table is designed so that data can be efficiently and intuitively analyzed, creation of a data summary table itself can be challenging for novice users. For example, some programs provide wizards that assist the user in creating a data summary table. While these wizards may be helpful in creating an initial data summary table, wizards cannot easily be used to modify the display once it is created and/or provide key performance indicators representative of the data being analyzed. Other programs allow users to drag and drop desired fields directly -onto the data summary table. While these programs provide the user with greater flexibility when creating the display, such programs can be less intuitive for a novice to use.

### SUMMARY

This summary is provided to introduce a selection of concepts in a simplified form that are further described below in the Detailed Description. This summary is not intended to identify key features of the claimed subject matter nor intended to be used as an aid in determining the scope of the claimed subject matter.

According to one aspect of the invention, key performance indicators and the accompanying key performance indicator elements may be displayed in a task pane to enable a user to select one or more key performance indicator elements for use in generating a data summary table. In one example, the key performance indicators of a dataset are identified and each of the associated key performance indicator elements associated with that key performance indicator is also identified. A key performance indicator may be obtained from any source, including the dataset to which it pertains. Additionally, a name of the identified key performance indicator is determined. The determined name and each of the identified key performance indicator elements are displayed in an organized manner so as to enable a user easy selection of the key performance indicator and/or the key performance indicator elements.

According to another aspect of the invention, key performance indicators may be displayed using graphical icons to provide a visual means for understanding the values of the key performance indicators. Upon selection of a key performance indicator, or key performance indicator element, in one embodiment, at least one property associated with the key performance indicator is determined. Additionally, a value of the key performance indicator representative of the key performance indicator property is determined. Based on the determined value, a graphical icon is assigned and displayed. The graphical icon is used to represent the value of the key performance indicator. In one example, the graphical icon is assigned based on a range in which the value of the key performance indicator falls. Different ranges may be assigned different graphical icons. Depending on the range in which the value of the key performance indicator falls, the appropriate graphical icon is assigned.

According to a yet another aspect of the invention, graphical icons that are displayed in a data summary table for a key performance indicator may be dynamically updated in response to a change to the data summary table. For example, if a user filters the data summary table, the value of the key performance indicator may change, and subsequently fall into a different range. As such, a different graphical icon, associated with the new range, may be displayed to replace the previously displayed graphical icon.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of an overall view illustrating the generation, selection, display, and dynamic update of a set of one or more KPIs in accordance with an embodiment of the present invention;

FIG. 2 illustrates a pictorial representation of a task pane that may be used to present KPIs and KPI elements to a user for easy selection in accordance with an embodiment of the present invention;

FIG. 3 is a pictorial representation of a selected KPI, KPI elements, and accompanying items, displayed in accordance with an embodiment of the present invention;

FIG. 4 is a pictorial representation of an icon drop down menu that allows a user to select the desired icon to be used to represent a value of a KPI element in accordance with an embodiment of the present invention;

FIG. 5 is a flow diagram of a task pane KPI generation routine for generating KPI names and KPI elements in a task pane in accordance with an embodiment of the present invention;

FIG. 6 is a flow diagram of a data summary table generation routine for generating a high-level representation of selected KPIs and KPI elements in accordance with an embodiment of the present invention; and

FIG. 7 is a flow diagram of a KPI dynamic update routine for dynamically updating displayed values representative of KPIs in response to a change in accordance with an embodiment of the present invention.

### DETAILED DESCRIPTION

Embodiments will now be described more fully hereinafter with reference to the accompanying drawings. Embodiments disclosed herein are examples and should not be construed as limiting.

Summary tables may be generated from a set of data to aid a user in understanding the contents of the data at a higher level. In addition to providing a typical summary table, embodiments of the present invention provide the ability to identify, understand, and represent Key Performance Indicators (“KPIs”). A KPI as used herein is a calculated value that may be used to provide a high-level representation of a set of data and may be used to represent trends, or the status of the data. For example, KPIs may represent global or regional sales figures and trends over time, personnel statistics and trends, real-time supply chain information, or anything else that is desired to be represented at a high-level.

KPIs may be computed from any type of information, such as a spreadsheet or database. For example, KPIs may be computed from data stored in an Excel spreadsheet, an Oracle® database, etc. Additionally, KPIs may be computed based on data stored in multiple locations and/or multiple databases. For purposes of this discussion, data used to compute a KPI is referred to herein as a “dataset.” It will be understood that a dataset may include one or more databases, or other sources of information, with any amount and type of data. KPIs may be defined and computed for a particular dataset in a multitude of ways. For example, KPIs may be manually defined by a user for use in representing a portion of a dataset. Alternatively, KPIs may be established and defined by an administrator of a corporation based on core information desired by the management of that corporation. For purposes of this application, KPIs may be defined and computed in any manner. Additionally, KPIs may be stored as part of a dataset or computed and stored separately.

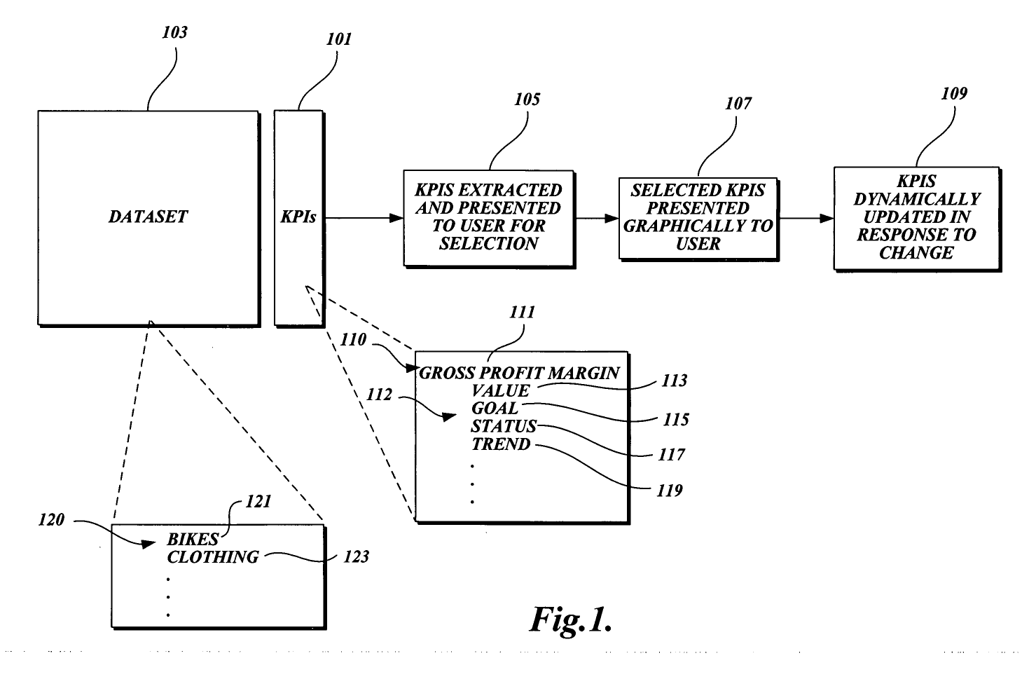

FIG. 1 is a block diagram of an overall view illustrating the generation, selection, display, and dynamic update of a set of one or more KPIs in accordance with an embodiment of the present invention. As noted above, KPIs 101 are computed from information maintained in a dataset 103. Additionally, the KPIs 101 may be part of the dataset 103 or maintained separately. Each KPI 101 defined for a dataset 103 may have a KPI name 110, such as Gross Profit Margin 111, and one or more KPI elements 112, such as value 113, goal 115, status 117, and trend 119. Any number of KPI elements may be specified. The KPI elements of value, goal, status, and trend are provided as examples only. Additionally, each KPI 101 may be associated with one or more items 120, such as bikes 121 and clothing 123.

The KPI elements typically represent the type of high-level information to be displayed by the KPI. Items 120 may represent the relevant data identifiers for which the high-level information is to be displayed. For example, the KPI 101 named Gross Profit Margin 111, if selected by a user, may present high-level information regarding the items 120 of bikes 121 and clothing 123. In particular, the KPI 101 named Gross Profit Margin 111 may present the actual gross profit margin of bikes and clothing represented, by KPI element value 113, the gross profit margin goal for bikes and clothing, represented by KPI element goal 115, the gross profit margin status for bikes and clothing, represented by KPI element status 117, and the-gross profit margin trend for bikes and clothing, represented by KPI element trend 119. Each of the KPI elements may be calculated from the information contained in the respective dataset 103.

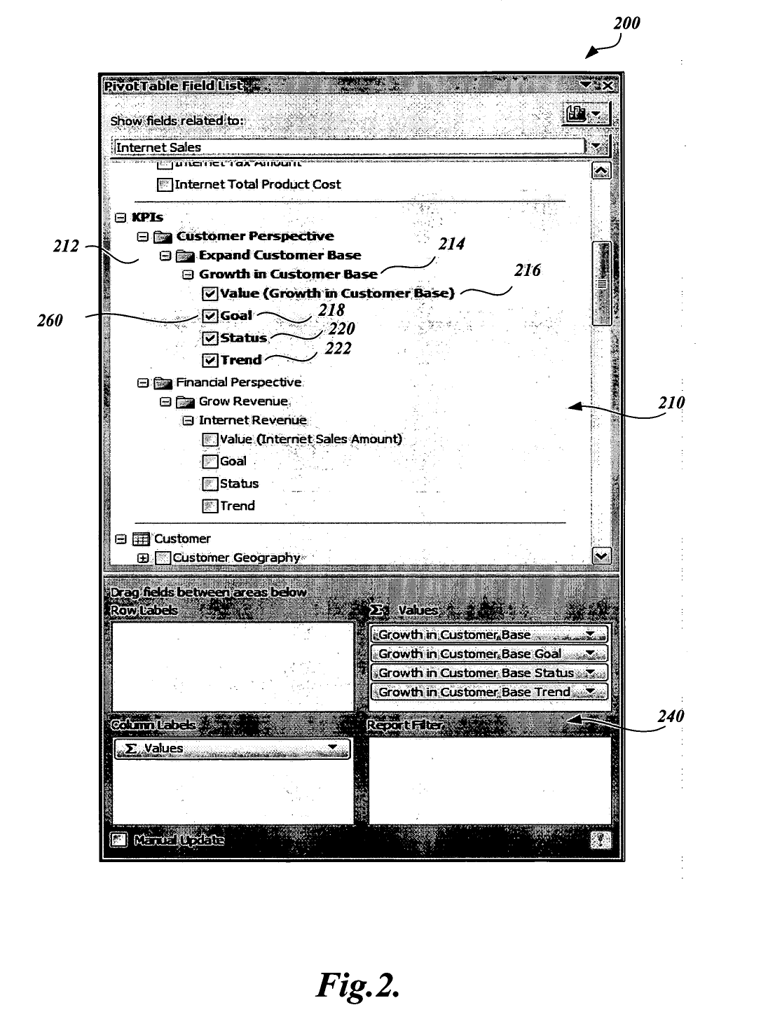

As noted by block 105, the KPI names 110 and KPI elements 112 defined for a particular dataset 103 may be identified and presented to a user in a friendly manner to allow selection by a user for use in generating a data summary table. As described in more detail below with respect to FIG. 2, a user may select a KPI name and one or more of its related KPI elements. For example, if a user selected the Gross Profit Margin 111 KPI, the user may also select one or all of the associated KPI elements of value 113, goal 115, status 117, and trend 119. In one embodiment, if the user selects the KPI name, all of the associated KPI elements will automatically be selected for inclusion in the data summary table.

Upon selection by a user, as illustrated by block 107, the selected KPIs and accompanying elements may be presented to a user. As described in more detail below, some calculated KPI elements 112, such as value 113 and goal 115, may be represented as the calculated numeric value. However, other KPI elements may be better represented as graphical indicators, or icons. For example, the KPI elements status 117 and trend 119 may be calculated in a manner that results in a value between the range of −1.0 and 1.0. As such, the value of the KPI element may be difficult to understand if presented as the numeric value. Accordingly, these types of KPI elements may be represented by a graphical identifier or icon representative of the value of the KPI element.

Additionally, as illustrated by block 109, KPIs displayed in a data summary table may be dynamically updated in response to changes made by a user. Referring to the KPI element trend 119, which may be computed over a specified period of time, the value of the KPI element may be dynamically updated in response to a user adjusting the timeframe for which the KPI should be computed. For example, if the KPI element trend 119 is representing the trend of bike sales over a five-year period, and the user adjusts the range to only cover three years, the value of the KPI element would dynamically update to represent the trend over the specified three year period.

FIG. 2 illustrates a pictorial representation of a task pane 200 that may be used to present KPI names and KPI elements to a user for easy selection in accordance with an embodiment of the present invention. The task pane 200 generally includes a field pane 210 and a layout pane 240. The task pane 200 is used to select desired KPIs and KPI elements for display to a user, as described further below.

The field pane 210 includes a folder list 212 of KPIs, identified by KPI names, for a given dataset. Each KPI has one or more associated KPI elements. For example the KPI named “Growth in Customer Base” 214, includes four KPI elements: value 216, goal 218, status 220, and trend 222. Each KPI element in list 212 includes a checkbox next to the element. For example, the KPI element goal 218 includes a checkbox 260 positioned adjacent to the KPI element caption. Techniques for displaying, selecting, and manipulating information in the task pane 200 are described in co-pending U.S. Pat. application No. 11/223,527, filed Sep. 9, 2005, entitled “User Interface for Creating a Spreadsheet Data Summary Table.”

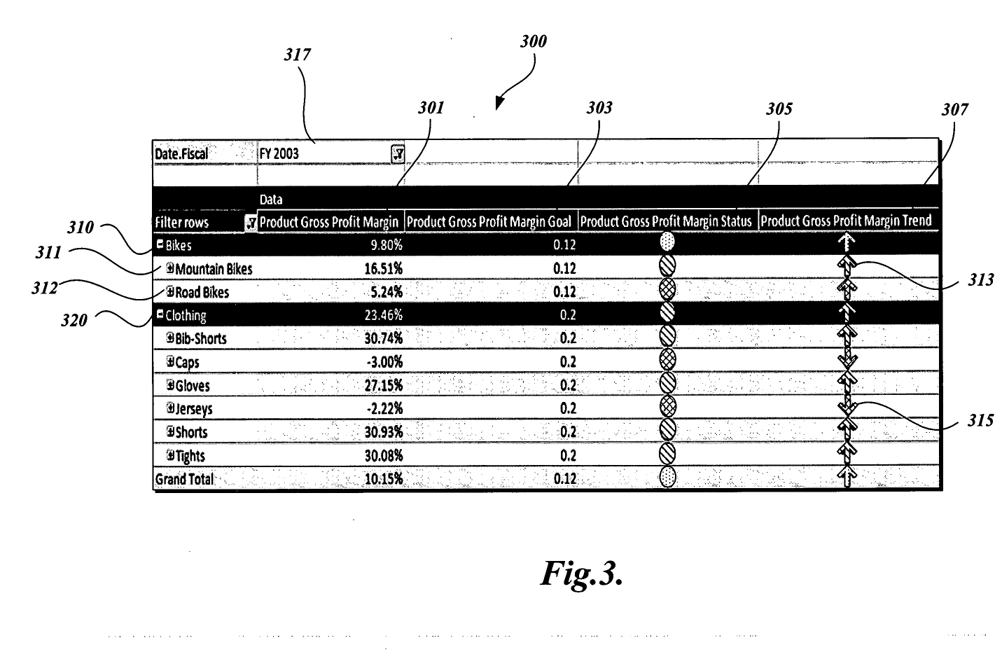

FIG. 3 is a pictorial representation of a selected KPI, KPI elements, values of KPI elements, and relevant items displayed in accordance with an embodiment of the present invention. When a KPI element displayed in a task pane 200 is selected, the KPI itself, the selected KPI elements, and the appropriate items will be graphically presented to the user. FIG. 3 illustrates the KPI named “Gross Profit Margin,” and the KPI elements of value 301, goal 303, status 305, and trend 307. To clarify the information being presented to a user, each KPI element displayed in the data summary table 300 may be preceded by the KPI Name “Product Gross Profit Margin.”

In addition to displaying the KPI elements, the accompanying items are also presented for the selected KPI. In this example, the items relevant to the KPI named “Product Gross Profit Margin” include bikes 310 and clothing 320. Items may be structured in a parent-child relationship allowing a user to drill down to more specific information. In one example, the items of bikes 310 is a parent item that includes two child items, mountain bikes 311 and road bikes 312. Parent-child structured items may be expanded or contracted to show all of the items or only the parent item. In one embodiment, each item may include a plus or minus box next to the item name. Selection of a plus box results in the item being expanded to show all child items and the box will change to a minus box. In contrast, selection of a minus box results in all exposed child items being encompassed within the parent item and the box changing to a plus box.

For each item, the appropriate value of the associated KPI elements is displayed, thereby providing a high-level overview of the dataset. As mentioned above, some values of KPI elements may be presented as the calculated value, such as the values of KPI element value 301 and KPI element goal 303, while others may be more easily understood when displayed as a graphical icon, such as KPI element status 305 and KPI element trend 307. Graphical icons may be used to illustrate values of KPI elements by assigning different icons to different ranges of values and displaying the appropriate icon for a particular value of a KPI element based on those ranges. For example, assuming the values for the KPI element trend 307 are computed such that they fall between −1.0 and 1.0 and three different icons are to be presented, the icons may be associated as follows:

1st icon for: −1.0≧value of KPI element <−0.5

2nd icon for: −0.5≧value of KPI element <0.5

3rd icon for: 0.5≧value of KPI element <1.0 While the above examples provides for a range between −1.0 and 1.0, any range may be used for associating icons with values of KPI elements. Additionally, any number and/or type of icons may be used to represent values of KPI elements.

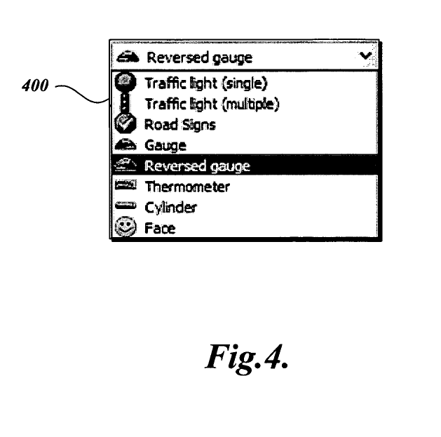

FIG. 4 is a pictorial representation of an icon drop down menu that allows a user to select the desired icon to be used to represent a value of a KPI element in accordance with an embodiment of the present invention. As shown in FIG. 4, the drop down menu 400 allows a user to select one of eight sets of graphical icons for use in representing values of KPI elements. It will be appreciated that any number of sets of graphical icons may be used with embodiments of the present invention. Providing a choice of graphical icons gives a user greater flexibility in viewing values of KPI elements. Each set of graphical icons includes one or more icons that can be associated with different ranges of values for representation.

In addition to selecting graphical icons from the drop down menu 400, a user may also adjust how many different icons from a set are to be presented. In one embodiment, a user may specify the number of ranges for which graphical icons are to be associated. Additionally, the user may specify the border values for those ranges. Still further, a user may specify which icons are to be associated with each range. As will be appreciated by one of ordinary skill in the relevant art, any number and combination of ranges, icons, values, etc., may be configured in accordance with embodiments of the present invention.

Referring again to FIG. 3, graphical icons are used to represent values of KPI element status 305 and KPI element trend 307. As can be seen from the example, the value of the KPI element trend 307 for each associated item is graphically represented by one of two icons. For items in which the trend value is positive, the value is represented with an up arrow 313. In contrast, trend values that are negative are represented by down arrows 315. Representing values of the KPI element trend 307 with graphical icons makes it is very easy for a user to understand whether a trend for an item, such as bikes 310, is positive, indicated by an up arrow, or negative, indicated by a down arrow.

In addition to providing graphical icons for some values of KPI elements, a user may filter the data summary table 300 and the graphical representation of values of KPI elements automatically update and dynamically change to match the new criteria specified by the user. For example, by using a filter tool 317, a user may specify the range for which a KPI is to be provided. In this example, a user has specified that the range for which a KPI is to be provided is fiscal year 2003. After viewing the results for that particular year, the filter may be changed, e.g., the user can filter to show results for fiscal year 2004, and the graphical representations for the values of the KPI elements will automatically update and the graphical icons automatically change to match the new information. Additionally, if a user selects to drill down into one of the properties by selecting the plus box, when the data summary table 300 expands to include the new items, the graphical representations for the values of the KPI elements associated with those items are dynamically updated and provided to the user in a manner consistent with the representation of the properties of the parent item.

Any type of modifications may be made to the data summary table 300 in response to which the graphical representations for values of KPI elements are dynamically updated. For example, the data summary table may be rearranged, items may be added, removed, and/or relocated, the KPIs can be sorted (based on name, value, goal, trend, status, etc.), and the data summary table layout can be altered, etc.

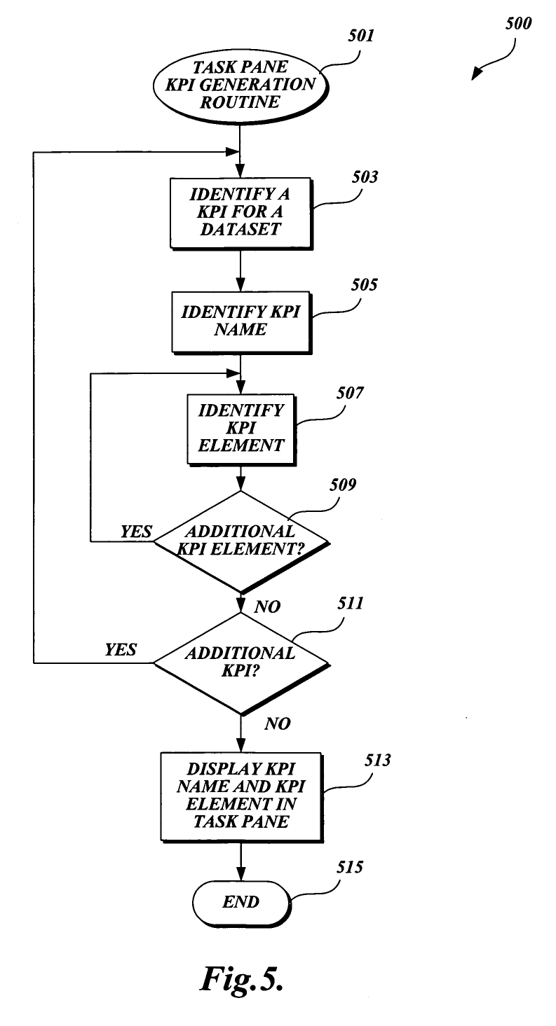

FIG. 5 is a flow diagram of a task pane KPI generation routine for generating KPI names and KPI elements in a task pane in accordance with an embodiment of the present invention. The KPI generation routine 500 begins at block 501. At block 503, a KPI for a dataset is identified. As discussed above, KPIs for a dataset may be defined and obtained in a variety of ways. In one example, the KPIs may be defined using an “online analytical processing” (OLAP) service. In another embodiment, the KPIs may be defined within an Excel® spreadsheet. KPIs may be defined and obtained from any source and/or location for use with embodiments of the present invention.

Upon identification of a KPI for a dataset, the KPI name for the dataset is determined, as illustrated by block 505. In addition to determining the KPI name, at block 507, a KPI element is identified for the KPI. At decision block 509, it is determined if there are additional KPI elements associated with the particular KPI. If it is determined at decision block 509 that there are additional KPI elements, control returns to block 507, and the routine continues.

However, if it is determined at decision block 509 that there are no additional KPI elements for the KPI identified at block 503, at decision block 511 it is determined if there are additional KPIs for the dataset for which a task pane is being generated. If it is determined at decision block 511 that there are additional KPIs for the dataset, control returns to block 503, and the routine continues. However, if it is determined at decision block 511 that there are no additional KPIs for the dataset, at block 513, each identified KPI name and associated KPI element(s) is displayed in the task pane. Upon display of the KPI names and KPI elements, the routine completes, as illustrated by decision block 515. In one embodiment, as illustrated in FIG. 2, KPI names and elements may be presented in a tree-based view and may further be organized by folders. In one example, the KPI elements of a KPI may be displayed as sub-items underneath a KPI name.

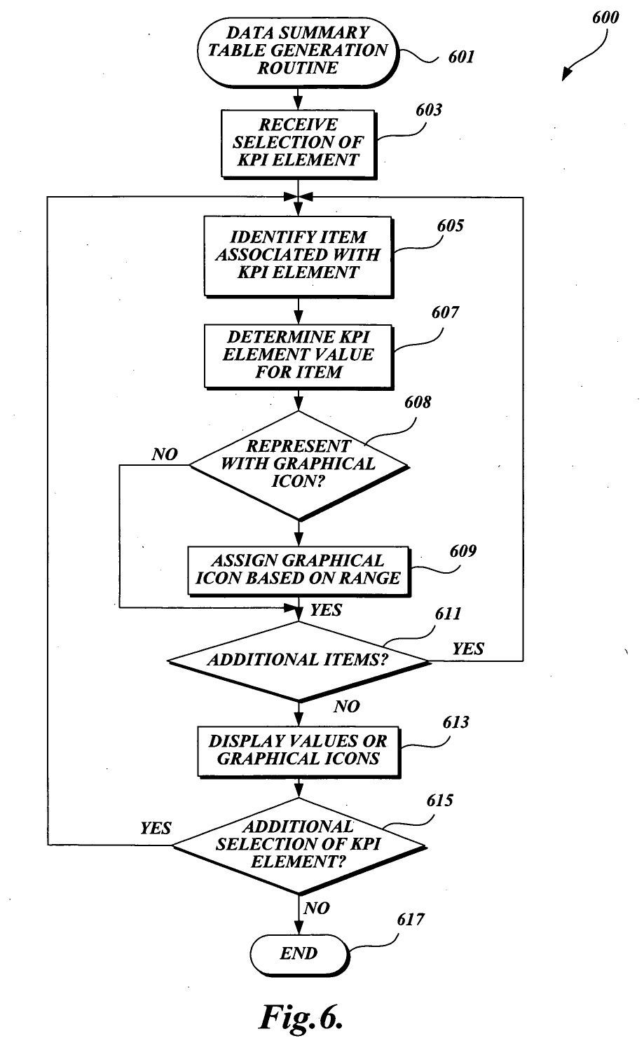

FIG. 6 is a flow diagram of a data summary table generation routine for generating a high-level representation of selected KPIs and KPI elements in accordance with an embodiment of the present invention. The data summary table generation routine 600 begins at block 601. At block 603, a selection of a KPI element is received. As discussed above, KPIs and KPI elements may be selected in a variety of manners via the task pane view.

Upon receipt of a KPI element selection, at block 605, an item associated with the selected KPI element is identified. At block 607, a value of the KPI element is determined for the item. At block 608, it is determined if the value of the KPI element should be displayed or if it should be represented as graphical icon. If it is determined that the value of the KPI element should be displayed as a graphical icon, at block 609, a graphical icon is assigned to the value based on a range in which the value falls. As discussed above, if a graphical icon is to be used to represent a value of a KPI element, a set of ranges may be specified, icons associated with each range, and the appropriate icon assigned to the value of the KPI element based on the range in which it falls.

After assigning a graphical icon to a value of a KPI element, or if it is determined at decision block 608 that the value of the KPI element is not to be represented by a graphical icon, at decision block 611 it is determined if there are additional items for the KPI selected at block 603. If it is determined at decision block 611 that there are additional items, control returns to block 605, and the routine continues. However, if it is determined at decision block 611 that there are no additional items for the selected KPI, at block 613, either a graphical icon is provided for the KPI element or the value of the KPI element is displayed.

At decision block 615, it is determined if a selection of an additional KPI element has been received. If it is determined at decision block 615 that an additional selection of a KPI element for a dataset has been received, control returns to block 605, and the routine continues. If it is determined that no additional KPI elements have been selected, the routine 600 completes, as illustrated by block 617.

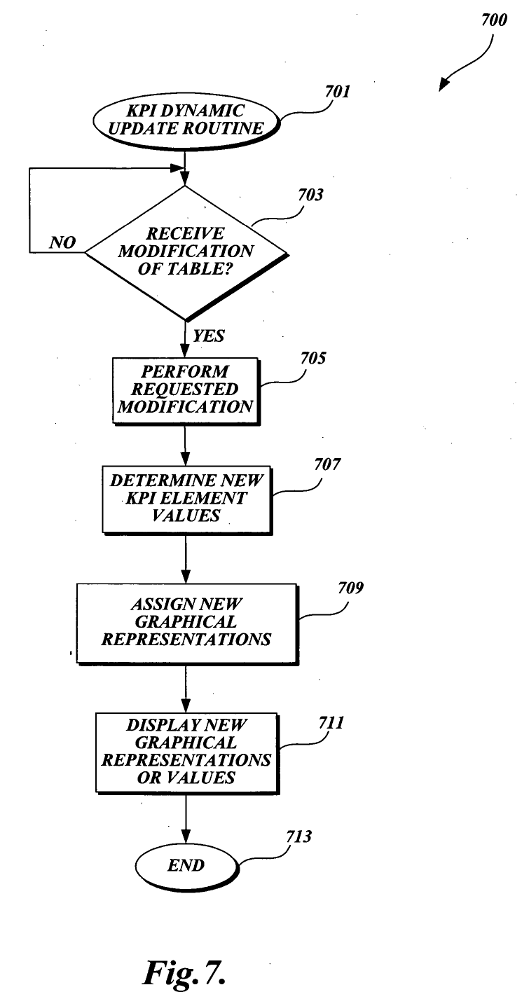

FIG. 7 is a flow diagram of a KPI dynamic update routine for dynamically updating displayed values representative of KPIs in response to a change in accordance with an embodiment of the present invention. The KPI dynamic update routine 700 begins at block 701. At decision block 703, a determination is made as to whether a change or modification has been made to a data summary table. If it is determined at decision block 701 that a change or modification has been made, at block 705 the requested change or modification is made to the data summary table. At block 707, new values for the displayed KPI elements in the data summary table are determined. At block 709, for KPI elements represented by graphical icons, new graphical icons are assigned based on the newly determined values of the displayed KPI elements.

Referring back to FIG. 6, if the values of the KPI elements are to be represented by a graphical icon, the appropriate icon is selected which is associated with a range in which the newly determined value falls. For values of KPI elements that are displayed as the value itself, the new value is simply updated and displayed, as illustrated by block 711. Additionally, at block 711, the newly assigned graphical icons are also displayed in the modified data summary table. The KPI dynamic update routine completes at block 713.

While illustrative embodiments have been illustrated and described, it will be appreciated that various changes can be made therein without departing from the spirit and scope of the invention.

1. A method for displaying a key performance indicator using a graphical icon, comprising:
receiving a selection of a key performance indicator;
identifying at least one property associated with the key performance indicator;
determining at least one value of the key performance indicator;
assigning a graphical icon with the value of the key performance indicator such that the graphical icon is representative of the value of the key performance indicator; and
displaying the graphical icon.

2. The method of claim 1, wherein the key performance indicator includes a key performance indicator element; and
wherein the value of the key performance indicator is a value of the key performance indicator element.

3. The method of claim 2, wherein the key performance indicator includes a second key performance indicator element; and
wherein determining at least one value includes determining a value for the key performance indicator element and determining a second value for the second key performance indicator element.

4. The method of claim 3, further comprising:
determining if the value of the key performance indicator and the second value for the second key performance indicator should be represented by graphical icons; and
in response to a determination that the second value for the second key performance indicator element should not be represented by a graphical icon, displaying the value of the second key performance indicator.

5. The method of claim 1, wherein the assigned graphical icon is associated with a range of values; and
wherein the graphical icon is assigned to the value of the key performance indicator based on the range in which the value of the key performance indicator falls.

6. The method of claim 1, wherein the displayed graphical icon is dynamic.

7. A computer readable medium have computer executable instructions for performing the method of generating a task pane including at least one key performance indicator and at least one key performance indicator element, comprising:
identifying a key performance indicator for a dataset;
identifying a key performance indicator element associated with the key performance indicator;
displaying a name representative of the identified key performance indicator; and
displaying visually near the displayed name of the key performance indicator the key performance indicator element.

8. The computer readable medium of claim 7, wherein the key performance indicator and the key performance indicator element are displayed in a task pane.

9. The computer readable medium of claim 7, wherein the key performance indicator element may be selected by a user and a value of the key performance indicator element displayed in a data summary table.

10. The computer readable medium of claim 7, wherein identifying a key performance indicator element associated with the key performance indicator includes identifying a plurality of key performance indicator elements associated with the key performance indicator.

11. The computer readable medium of claim 7, wherein the key performance indicator element is selected from a group of key performance indicator elements including value, goal, status, trend.

12. The computer readable medium of claim 7, wherein the key performance indicator represents a high-level view of a portion of information contained in a dataset.

13. A method for displaying a graphical icon with a value of a key performance indicator element using graphical icons, comprising:
identifying a key performance indicator for a dataset, wherein the key performance indicator includes a key performance indicator element;
identifying an item associated with the key performance indicator;
determining a value of the key performance indicator element representative of the item for the dataset;
identifying a range of values between which the value of the key performance indicator falls;
assigning a graphical icon to the value of the key performance indicator based on the identified range; and
displaying the assigned graphical icon in a data summary table.

14. The method of claim 13, wherein the range is selected from a group of ranges, wherein each range is associated with a different graphical icon.

15. The method of claim 14, wherein each of the graphical icons represents a quality of the key performance indicator.

16. The method of claim 14, wherein a positive graphical icon is associated with a first range and a negative graphical icon is associated with a second range.

17. The method of claim 13, wherein the displayed graphical icon is dynamic.

18. The method of claim 13, wherein the displayed graphical icon is automatically updated in response to a change to the data summary table.

19. The method of claim 13, wherein the displayed graphical icon is automatically updated in response to a filtering of the data summary table.

20. The method of claim 13, wherein the displayed graphical icon provides a high-level view of information contained in a dataset.
